(19) United States
(12) Patent Application Publication
(10) Pub. No.: US 2023/0391336 A1
(43) Pub. Date: Dec. 7, 2023

(54) APPARATUS FOR DRIVER ASSISTANCE AND METHOD FOR DRIVER ASSISTANCE

(71) Applicant: HL KLEMOVE CORP., Incheon (KR)

(72) Inventor: Woojin SOHN, Gyeonggi-do (KR)

(21) Appl. No.: 18/207,037

(22) Filed: Jun. 7, 2023

(30) Foreign Application Priority Data
Jun. 7, 2022 (KR) 10-2022-0069023

(51) Int. Cl. B60W 30/18

(52) U.S. Cl. CPC B60W 30/18159; B60W 2420/42; B60W 2420/52; B60W 2556/40; B60W 2552/05; B60W 2552/10; B60W 2552/53

(57) ABSTRACT

Disclosed herein is an apparatus for driver assistance including a sensor installed in a host vehicle, including at least one of a camera or a radar, and configured to output data; a memory in which a precision map including intersection information is stored, and at least one processor electrically connected to the memory and configured to process the data output from the sensor. The at least one processor may generate a grid map by connecting lane lines of an intersection on the precision map when the host vehicle makes a left turn at the intersection, select a start point and an end point required for the left turn on the grid map, select at least one control point according to a minimum turning radius of the host vehicle or an opposite left-turn vehicle, generate a rational Bezier curve based on the start point, the end point, the at least one control point, and determine the rational Bezier curve to be a left-turn path that the host vehicle follows, and control the host vehicle based on the processing of the data such that the host vehicle follows the left-turn path.

### CROSS-REFERENCE TO RELATED APPLICATION

This application claims the benefit of Korean Patent Application No. 10-2022-0069023, filed on Jun. 7, 2022 in the Korean Intellectual Property Office, the disclosure of which is incorporated herein by reference.

### BACKGROUND

### 1. Field

Embodiments of the present disclosure relate to a apparatus for driver assistance and a method for driver assistance capable of securing traveling safety at an intersection.

### 2. Description of the Related Art

Generally, a path planning logic, which is commonly encountered among various scenarios that need to cope with for the implementation of autonomous traveling in city streets, is essential to prevent accidents at an intersection and safely passes an intersection.

Compared to normal straight roads, an intersection situation in the city has much uncertainty about the future because a vehicle behavior is diverse, occurring scenarios are complex, and sizes and types of intersections are also diverse. This makes safe and accurate path planning difficult.

### SUMMARY

Therefore, it is an aspect of the present disclosure to provide an apparatus for driver assistance and a method for driver assistance, which may plan and provide a safe reference path in which a host vehicle may follow at an intersection, thereby securing traveling safety at the intersection.

It is another aspect of the present disclosure to provide an apparatus for driver assistance and a method for driver assistance, which may plan and provide a safe reference path that a host vehicle may follow with respect to all intersections in the city, thereby securing traveling safety regardless of a size or type of the intersection.

Additional aspects of the disclosure will be set forth in part in the description which follows and, in part, will be obvious from the description, or may be learned by practice of the disclosure.

In accordance with one aspect of the present disclosure, an apparatus includes a sensor installed in a host vehicle, including at least one of a camera or a radar, and configured to output data; a memory in which a precision map including intersection information is stored, and at least one processor electrically connected to the memory and configured to process the data output from the sensor. The at least one processor may generate a grid map by connecting lane lines of an intersection on the precision map when the host vehicle makes a left turn at the intersection, select a start point and an end point required for the left turn on the grid map, select at least one control point according to a minimum turning radius of the host vehicle or an opposite left-turn vehicle, generate a rational Bezier curve based on the start point, the end point, the at least one control point, and determine the rational Bezier curve to be a left-turn path that the host vehicle follows, and control the host vehicle based on the processing of the data such that the host vehicle follows the left-turn path.

The at least one processor may determine a type of the intersection based on the intersection information of the precision map.

The at least one processor may select the at least one control point according to the minimum turning radius of the opposite left-turn vehicle when the type of the intersection is a cross intersection.

The at least one processor may select a position point spaced a preset distance from the minimum turning radius of the opposite left-turn vehicle as the at least one control point.

The at least one processor may determine a weight that changes a curvature of the rational Bezier curve so that a distance value between a path of the minimum turning radius of the opposite left-turn vehicle and a path of the rational Bezier curve is greater than a preset safety distance value, and generate the rational Bezier curve based on the start point, the end point, the at least one control point, and the weight.

The at least one processor may determine a weight that changes a curvature of the rational Bezier curve so that a distance value between a path of the minimum turning radius of the opposite left-turn vehicle and a path of the rational Bezier curve is greater than a preset safety distance value and a minimum heading angle of the host vehicle is smaller than a preset angle, and generate the rational Bezier curve based on the start point, the end point, the at least one control point, and the weight.

The at least one processor may select the at least one control point according to the minimum turning radius of the host vehicle when the type of the intersection is another intersection different from a cross intersection. The other intersection may include any one of a T-type intersection, a Y-type intersection, a five-way intersection, and a six-way intersection.

The at least one processor may select a position point spaced a preset distance from the minimum turning radius of the host vehicle as the at least one control point.

The at least one processor may determine a weight that changes a curvature of the rational Bezier curve so that a distance value between a path of a minimum turning radius of a left-turn vehicle in a next lane and a path of the rational Bezier curve is greater than a preset safety distance value, and generate the rational Bezier curve based on the start point, the end point, the at least one control point, and the weight.

The at least one processor may determine a weight that changes a curvature of the rational Bezier curve so that a distance value between a path of a minimum turning radius of a left-turn vehicle in a next lane and a path of the rational Bezier curve is greater than a preset safety distance value and a minimum heading angle of the host vehicle is smaller than a preset angle, and generate the rational Bezier curve based on the start point, the end point, the at least one control point, and the weight.

In accordance with another aspect of the present disclosure, a method includes acquiring data output from a sensor, the sensor installed in a host vehicle, including at least one of a camera or a radar, and configured to output data, acquiring a precision map in which intersection information is stored when a vehicle makes a left turn at an intersection, generating a grid map by connecting lane lines of the intersection on the acquired precision map, selecting a start point and an end point required for the left turn on the grid map, selecting at least one control point according to a minimum turning radius of a host vehicle or an opposite left-turn vehicle, generating a rational Bezier curve based on the start point, the end point, and the at least one control point, determining the rational Bezier curve to be a left-turn path that the host vehicle follows, and controlling the host vehicle based on the processing of the data such that the host vehicle follows the left-turn path.

The selecting of the at least one control point may include determining a type of the intersection based on the intersection information of the acquired precision map.

The selecting of the at least one control point may include selecting the at least one control point according to the minimum turning radius of the opposite left-turn vehicle when the type of the intersection is a cross intersection.

The selecting of the at least one control point may include selecting a position point spaced a preset distance from the minimum turning radius of the opposite left-turn vehicle as the at least one control point.

The generating of the rational Bezier curve may include determining a weight that changes a curvature of the rational Bezier curve so that a distance value between a path of the minimum turning radius of the opposite left-turn vehicle and a path of the rational Bezier curve is greater than a preset safety distance value, and generating the rational Bezier curve based on the start point, the end point, the at least one control point, and the weight.

The generating of the rational Bezier curve may include determining a weight that changes a curvature of the rational Bezier curve so that a distance value between a path of the minimum turning radius of the opposite left-turn vehicle and a path of the rational Bezier curve is greater than a preset safety distance value and a minimum heading angle of the host vehicle is smaller than a preset angle, and generating the rational Bezier curve based on the start point, the end point, the at least one control point, and the weight.

The selecting of the at least one control point may include determining a type of the intersection based on the intersection information of the acquired precision map, and selecting the at least one control point according to the minimum turning radius of the host vehicle when the type of the intersection is another intersection different from rather than a cross intersection. The other intersection includes any one of a T-type intersection, a Y-type intersection, a five-way intersection, and a six-way intersection.

The selecting of the at least one control point may include selecting a position point spaced a preset distance from the minimum turning radius of the host vehicle as the at least one control point.

The generating of the rational Bezier curve may include determining a weight that changes a curvature of the rational Bezier curve so that a distance value between a path of a minimum turning radius of a left-turn vehicle in a next lane and a path of the rational Bezier curve is greater than a preset safety distance value, and generating the rational Bezier curve based on the start point, the end point, the at least one control point, and the weight.

The generating of the rational Bezier curve may include determining a weight that changes a curvature of the rational Bezier curve so that a distance value between a path of a minimum turning radius of a left-turn vehicle in a next lane and a path of the rational Bezier curve is greater than a preset safety distance value and a minimum heading angle of the host vehicle is smaller than a preset angle, and generating the rational Bezier curve based on the start point, the end point, the at least one control point, and the weight.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a control block diagram of an apparatus for driver assistance according to an embodiment;

FIG. 2 is a control flowchart of a method for driver assistance according to an embodiment;

FIG. 3 is a view for describing generating a left-turn reference path according to a cross intersection in the method for driver assistance according to the embodiment;

FIG. 4 is a view for describing generating a grid map at a cross intersection and selecting a start point and an end point required for a left turn in the apparatus for driver assistance according to the embodiment;

FIG. 5 is a view for describing selecting two control points according to a minimum turning radius of an opposite vehicle in the apparatus for driver assistance according to the embodiment;

FIG. 6 is a view for describing generating a first rational Bezier curve based on four points and a first weight in the apparatus for driver assistance according to the embodiment;

FIG. 7 is a view for describing performing autonomous traveling control by determining the first rational Bezier curve to be a first reference path in the apparatus for driver assistance according to the embodiment;

FIG. 8 is a view for describing generating left-turn reference paths according to another intersection in the method or driver assistance according to the embodiment;

FIG. 9 is a view for describing generating a grid map at another intersection and selecting a start point and an end point required for a left turn in the apparatus for driver assistance according to the embodiment;

FIG. 10 is a view for describing selecting two control points according to a minimum turning radius of a host vehicle in the apparatus for driver assistance according to the embodiment;

FIG. 11 is a view for describing generating a second rational Bezier curve based on four points and a second weight in the apparatus for driver assistance according to the embodiment; and

FIG. 12 is a view for describing performing autonomous traveling control by determining the second rational Bezier curve to be a second reference path in the apparatus for driver assistance according to the embodiment.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

The expression, “at least one of a, b, and c,” should be understood as including only a, only b, only c, both a and b, both a and c, both b and c, or all of a, b, and c.

Reference will now be made in detail to the exemplary embodiments of the present disclosure, examples of which are illustrated in the accompanying drawings, wherein like reference numerals refer to like elements throughout.

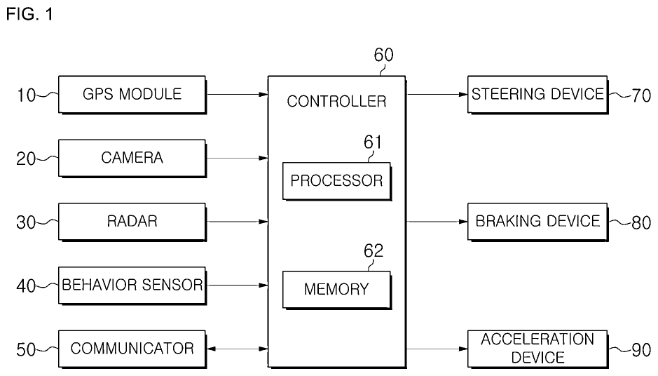

FIG. 1 is a control block diagram of an apparatus for driver assistance according to an embodiment.

Referring to FIG. 1, the apparatus for driver assistance may include a global positioning system (GPS) module 10, a camera 20, a radar 30, a behavior sensor 40, a communicator 50, and a controller 60.

The controller 60 may perform the overall control of the apparatus for driver assistance.

The controller 60 may be electrically connected to the GPS module 10, the camera 20, the radar 30, the behavior sensor 40, and the communicator 50.

The controller 60 may control a steering device 70, a braking device 80, and an acceleration device 90. The steering device 70 may change a traveling direction of a vehicle under the control of the controller 60. The braking device 80 may decelerate the vehicle by braking wheels of the vehicle under the control of the controller 60. The acceleration device 90 may accelerate the vehicle by driving an engine and/or a driving motor for providing a driving force to the vehicle under the control of the controller 60. The controller 60 may also be electrically connected to other electronic devices of the vehicle to control other electronic devices.

The GPS module 10 is a position information module for acquiring vehicle position information and may receive, for example, GPS signals including navigation data from at least one GPS satellite. The vehicle may acquire a position and traveling direction of the vehicle based on the GPS signals.

The camera 20 may be installed in the vehicle to have a forward field of view of the vehicle and may acquire forward image data of the vehicle by capturing the a forward view of the vehicle. The forward image data may include the forward image data of the vehicle captured through the camera 20, is not limited thereto and may also include image data of outward views of both sides and the rear of the vehicle.

The camera 20 may identify other vehicles around the vehicle.

The camera 20 may include a plurality of lenses and an image sensor. The image sensor may include a plurality of photodiodes for converting light into electrical signals, and the plurality of photodiodes may be disposed in the form of a two-dimensional matrix.

The camera 20 may transmit the forward image data of the vehicle to the controller 60.

The radar 30 may acquire relative positions, relative speeds, and the like with other vehicles around the vehicle.

The radar 30 may be installed in the vehicle to have an outward field of view of the vehicle and may acquire radar data for the outward field of view of the vehicle. The radar data may be data including images of other vehicles around the vehicle, which are present in the outward field of view of the vehicle. The driver assistance system may include a light detection and ranging (LiDAR) instead of the radar or include both the radar and the LiDAR.

The camera 20 may have a forward field of view of a vehicle 1. For example, the camera 20 may be installed on a front windshield of the vehicle 1. The camera 20 may capture a forward view of the vehicle 1 and acquire forward image data of the vehicle 1. The forward image data of the vehicle 1 may include position information on other vehicles positioned in front of the vehicle 1.

The radar 30 may have a sensing area of the vehicle 1. The radar 30 may be installed, for example, on a grille or a bumper of the vehicle 1.

The radar 30 may include a transmission antenna (or a transmission antenna array) for radiating transmission radio waves in a forward direction of the vehicle 1 and a reception antenna (or a reception antenna array) for receiving reflected radio waves reflected from an object. The radar 30 may acquire radar data from the transmission radio waves transmitted by the transmission antenna and the reflected radio waves received by the reception antenna.

The radar data may include distance information and speed information of other vehicles positioned in front of the vehicle 1.

The radar 30 may calculate a relative distance to another vehicle based on a phase difference (or a time difference) between the transmission radio waves and the reflected radio waves and calculate a relative speed of another vehicle based on a frequency difference between the transmission radio waves and the reflected radio waves.

Referring back to FIG. 1, the controller 60 may detect and/or identify other vehicles in front of the vehicle 1 and acquire position information (distances and directions) and speed information (relative speeds) of other vehicles in front of the vehicle 1 based on the forward image data of the camera 20 and the forward radar data of the radar 30.

Referring back to FIG. 1, the behavior sensor 40 may acquire behavior data of the vehicle. For example, the behavior sensor 40 may include a speed sensor for detecting a speed of a wheel, an acceleration sensor for detecting a lateral acceleration and a longitudinal acceleration of the vehicle, a yaw rate sensor for detecting a yaw rate of the vehicle, a steering angle sensor for detecting a steering angle of a steering wheel, and/or a torque sensor for detecting a steering torque of the steering wheel. The behavior data may include the speed of the wheel, the lateral acceleration, the longitudinal acceleration, the yaw rate, the steering angle, and/or the steering torque.

The communicator 50 may communicate with a server and receive a high definition map (hereinafter referred to as “HD map”) and position information of the vehicle from the server in real time. In this case, the HD map is a map expressed in detail in units of lane lines and may include intersections, general roads, lane lines such as center lines and boundary lines, and road equipment, such as traffic lights, road signs, and road surface marks.

The communicator 50 may include one or more components enabling communication with external devices and include, for example, a wireless Internet module, a short-range communication module, an optical communication module, and the like. The wireless Internet module refers to a module for wireless Internet access and may be embedded into or externally mounted on the vehicle. The wireless Internet module may transmit and receive wireless signals via a communication network based on wireless Internet techniques. The wireless Internet techniques include, for example, wireless LAN (WLAN), Wi-Fi, Wi-Fi Direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), 5G networks, 6G networks, and the like. The short-range communication module is for short-range communication and may support the short-range communication using at least one of Bluetooth™, radio frequency identification (RFID), infrared data association (IrDA), ultra-wideband (UWB), ZigBee, near field communication (NFC), Wi-Fi, Wi-Fi Direct, and wireless universal serial bus (USB) techniques. The optical communication module may include an optical transmitter and an optical receiver.

The communicator 50 may receive position and traveling information of other vehicles around the host vehicle through vehicle to everything (V2X).

Each of the GPS module 10, the camera 20, the radar 30, the behavior sensor 40, and the communicator 50 may include a controller (electronic control unit (ECU)). The controller 60 may also be implemented as an integrated controller including the controller of the GPS module 10, the controller of the camera 20, the controller of the radar 30, the controller of the behavior sensor 40, and the controller of the communicator 50.

The controller 60 may include a processor 61 and a memory 62.

The controller 60 may include one or more processors 61. The one or more processors 61 included in the controller 60 may be integrated into one chip or may also be physically separated. In addition, the processor 61 and the memory 62 may also be implemented as a single chip.

The processor 61 may process the GPS signals acquired by the GPS module 10, the forward image data acquired by the camera 20, the radar data acquired by the radar 30, the HD map data, and the like. In addition, the processor 51 may generate control signals for autonomous traveling of the vehicle, such as a steering signal for controlling the steering device 70, a braking signal for controlling the braking device 80, and an acceleration signal for controlling the acceleration device 90.

For example, the processor 61 may include an analog signal/digital signal processor for processing the GPS signal acquired by the GPS module 10, an image signal processor for processing the forward image data of the camera 20, a digital signal processor for processing the radar data of the radar 30, and a micro controller unit (MCU) for generating the steering signal, the braking signal, and the acceleration signal.

The memory 62 may store programs and/or data for the processor 61 to process the image data. The memory 62 may store programs and/or data for the processor 61 to process the radar data. In addition, the memory 62 may store programs and/or data for the processor 61 to generate the control signals for the components of the vehicle. In addition, the memory 62 may store HD map data stored inside thereof or provided from the server. The memory 62 may temporarily store data received from the GPS module 10, the camera 20, and the radar 30. In addition, the memory 62 may temporarily store results of processing the GPS signal, the image data, and the radar data by the processor 61. The memory 62 may include not only volatile memories, such as a static random access memory (SRAM) and a dynamic RAM (DRAM) but also non-volatile memories, such as a flash memory, a read only memory (ROM) and an erasable programmable ROM (EPROM).

The controller 60 having the above configuration acquires precision map data from the HD map, determines a type of an intersection from the precision map data, connects lane lines within the intersection according to the type of the intersection to generate a grid map, selects a start point and an end point required for a left turn with respect to landmarks on the grid map, selects two control points based on a minimum turning radius of an opposite left-turn vehicle or selects two control points based on a minimum turning radius of a host vehicle according to the type of the intersection, determines a weight satisfying a safety distance and a minimum heading angle according to the type of the intersection, generates a rational Bezier curve based on four points and the weight, determines the rational Bezier curve to be a left-turn reference path that the host vehicle follows, and performs autonomous traveling control for allowing the host vehicle to autonomously travel along the left-turn reference path.

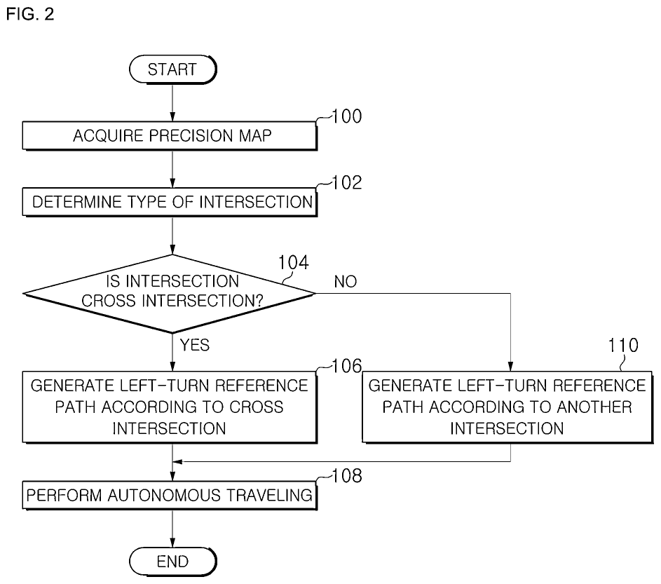

FIG. 2 is a control flowchart of a method for driver assistance according to an embodiment.

Referring to FIG. 2, first, the controller 60 acquires the precision map data from the HD map (100) and determines the type of the intersection from the precision map data (102). The controller 60 may determine a type of the current intersection by combining the type and number of road edges and a traveling direction of the host vehicle from the precision map data.

The controller 60 determines whether the type of the current intersection is a cross intersection (104).

In operation mode 104, when the type of the current intersection is the cross intersection (Yes in 104), the controller 60 generates a left-turn reference path according to the cross intersection (106). In addition, the controller 60 performs autonomous traveling control so that the host vehicle autonomously travels along the left-turn reference path according to the cross intersection (108).

Meanwhile, in operation mode 104, when the type of the current intersection is not the cross intersection (No in 104), the controller 60 generates a left-turn reference path according to another intersection (110). In addition, the controller 60 performs autonomous traveling control so that the host vehicle autonomously travels along the left-turn reference path according to another intersection (108). Another intersection may include a T-type intersection, a Y-type intersection, and multiple-way intersections (a five-way intersection, a six-way intersection, and the like) excluding a quadrangle intersection.

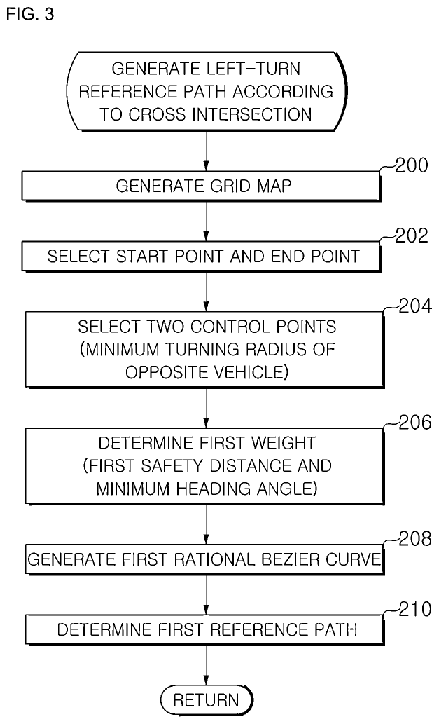

FIG. 3 is a view for describing generating a left-turn reference path according to a cross intersection in the method for driver assistance according to the embodiment.

Referring to FIG. 3, the controller 60 generates the grid map by connecting the lane lines within the cross intersection on a precision map (200).

Since there is no lane line for the host vehicle to follow in the cross intersection, the controller 60 generates the grid map by connecting the lane lines within the cross intersection using the precision map in order to generate a path for the host vehicle to follow.

The controller 60 selects a start point SP and an end point EP required for a left turn with respect to landmarks on the grid map (202).

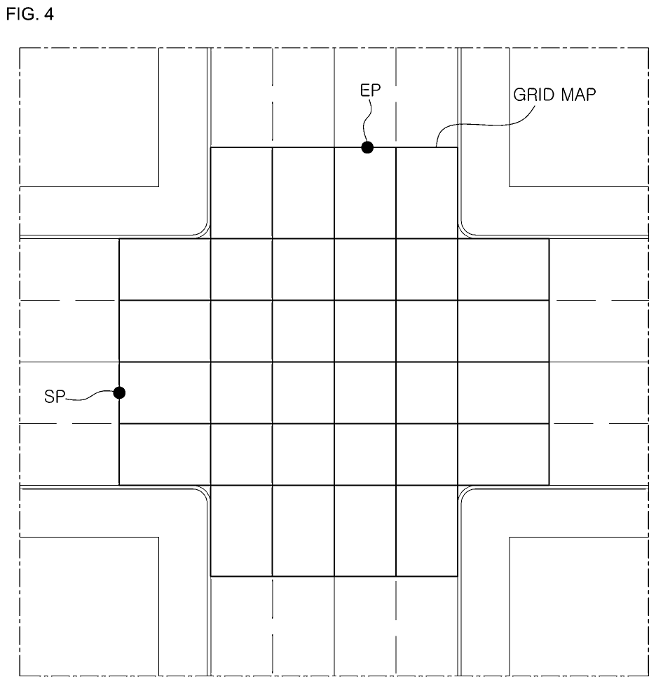

FIG. 4 is a view for describing generating a grid map at a cross intersection and selecting a start point and an end point required for a left turn in the apparatus for driver assistance according to the embodiment.

Referring to FIG. 4, it is assumed that the host vehicle makes a left turn from a first west lane to a first north lane of the cross intersection.

Since coordinate values of the lane lines may be acquired as global coordinates from the precision map, the grid map is generated by extending the lane lines within the cross intersection.

The controller 60 selects the start point SP and the end point EP required for the left turn with respect to the landmarks on the grid map.

Referring back to FIG. 3, the controller 60 selects two control points CP1 and CP2 based on the minimum turning radius of the opposite vehicle making a left turn at the opposite side of the cross intersection (204). The two control points CP1 and CP2 are one example, and three or more control points are also possible.

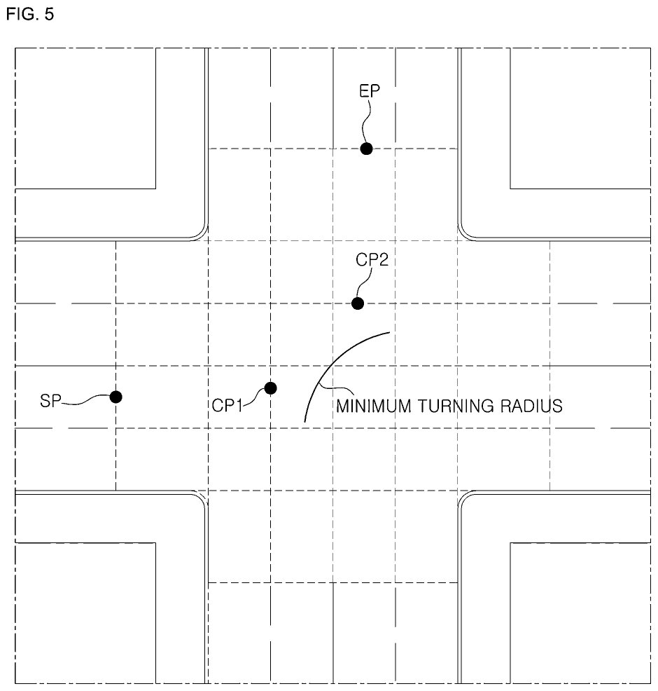

FIG. 5 is a view for describing selecting two control points according to a minimum turning radius of an opposite vehicle in the apparatus for driver assistance according to the embodiment.

Referring to FIG. 5, it is possible to know the minimum turning radius of the opposite vehicle, which makes a left turn at the opposite side, on the grid map. The minimum turning radius may be determined from a wheel base, a king pin, and a steering angle of the opposite vehicle. The minimum turning radius may be a preset value. The minimum turning radius may be a preset value according to the size of the cross intersection.

The two control points CP1 and CP2 are determined from the minimum turning radius of the opposite vehicle. For example, the two control points CP1 and CP2 may be determined as position points spaced a lane width from the minimum turning radius of the opposite vehicle. That is, the control points CP1 and CP2 of the rational Bezier curve are selected in consideration of the minimum turning radius of the opposite vehicle when the opposite vehicle hurry making a left turn.

Referring back to FIG. 3, the controller 60 determines a first weight of a first rational Bezier curve satisfying a first safety distance and a minimum heading angle to generate the first rational Bezier curve spaced the first safety distance or more from the minimum turning radius of the opposite vehicle and satisfying the minimum heading angle (206).

The controller 60 generates the first rational Bezier curve based on the four points and the first weight (208).

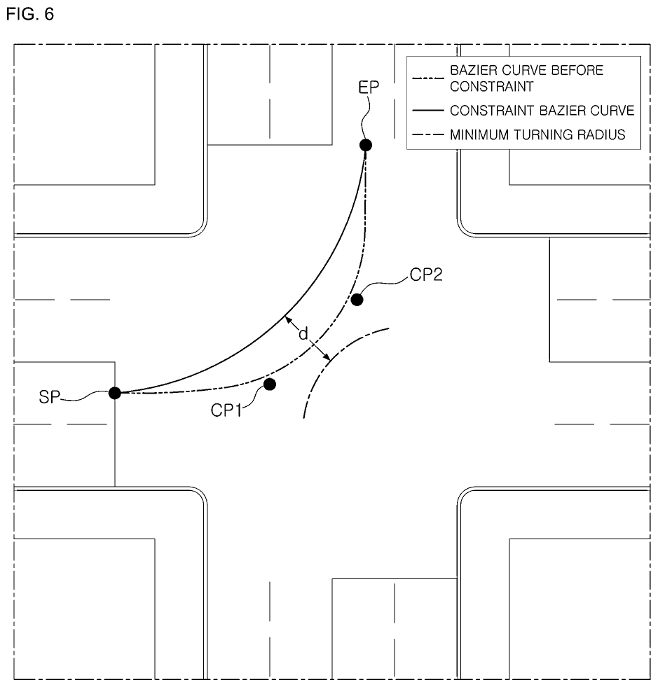

FIG. 6 is a view for describing generating a first rational Bezier curve based on four points and a first weight in the apparatus for driver assistance according to the embodiment.

Referring to FIG. 6, the first rational Bezier curve B(t) is expressed as Equation 1 below.

$$B ( t ) = \frac{{\sum }_{i = 0}^{n} {P}_{i} {b}_{n , i} ( t ) {w}_{i}}{{\sum }_{i = 0}^{n} {b}_{n , i} ( t ) wi} , t ∈ [ 0 , 1 ] \qquad [ Equation 1 ]$$

$$P = \{ \begin{matrix}{P}_{0} = [ \begin{matrix}{x}_{start} & {y}_{start} ]\end{matrix} \\ {P}_{1} = [ \begin{matrix}{x}_{c , 1} & {y}_{c , 1}\end{matrix} ] \\ {P}_{2} = [ \begin{matrix}{x}_{c , 2} & {y}_{c , 2}\end{matrix} ] \\ {P}_{3} = [ \begin{matrix}{x}_{end} & {y}_{end}\end{matrix} ]\end{matrix}$$

Pᵢ denotes the control points (start point, end point, and two control points), and b_{n,i} denotes a Bernstein basis polynomial of order n. The numerator is a Bezier curve of a weighted Bernstein form, and the denominator is a weighted sum of Bernstein polynomials. A type of the curve is determined by a first weight wᵢ, and a range of the curve is w∈[0,1].

The type of the first rational Bezier curve is changed according to a value of the first weight.

A maximum curvature of the first rational Bezier curve is a minimum radius of curvature, and the larger the radius of curvature, the closer the curve is to a straight line.

Constraint condition elements that adjust the curvature of the first rational Bezier curve are the first safety distance d and the minimum heading angle θ.

The first safety distance d denotes a separation distance between a path of the minimum turning radius of the opposite vehicle and a path of the first rational Bezier curve. Upon making a left turn with the minimum turning radius, the opposite vehicle maximally approaches the left-turn path of the host vehicle. In order to cope with this case, the path of the host vehicle needs to be spaced the safety distance or more from the path of the opposite vehicle. For example, the constraint condition for the first safety distance is a condition (d≥3.5 m) in which the first safety distance is greater than or equal to a lane width of 3.5 m.

The minimum heading angle is an angle between the path of the first rational Bezier curve and the road. The minimum heading angle is a heading angle at which the host vehicle may smoothly enter the road when making a left turn. For example, the constraint condition for the minimum heading angle is a condition (θ<0.5 deg) in which the minimum heading angle is smaller than 0.5 deg.

The first rational Bezier curve determines the first weight that satisfies the constraint condition for the first safety distance and the constraint condition for the minimum heading angle. That is, when the first rational Bezier curve is generated, the first weight is determined so that the conditions in which the first safety distance is greater than or equal to the lane width of 3.5 m and the minimum heading angle is smaller than 0.5 deg are satisfied and the first rational Bezier curve is generated as a smooth curve with a minimized curvature. In this case, the first weight may be a weight that satisfies only the constraint condition for the first safety distance.

The first rational Bezier curve is generated based on the start point SP, the end point EP, the two control points CP1 and CP2, and the first weight. It can be seen that the curvature of the rational Bezier curve before constraint is changed to that of a constraints rational Bezier curve by the first weight that satisfies the first safety distance and the minimum heading angle.

Referring back to FIG. 3, the controller 60 generates the first rational Bezier curve as the first reference path that the vehicle follows (210).

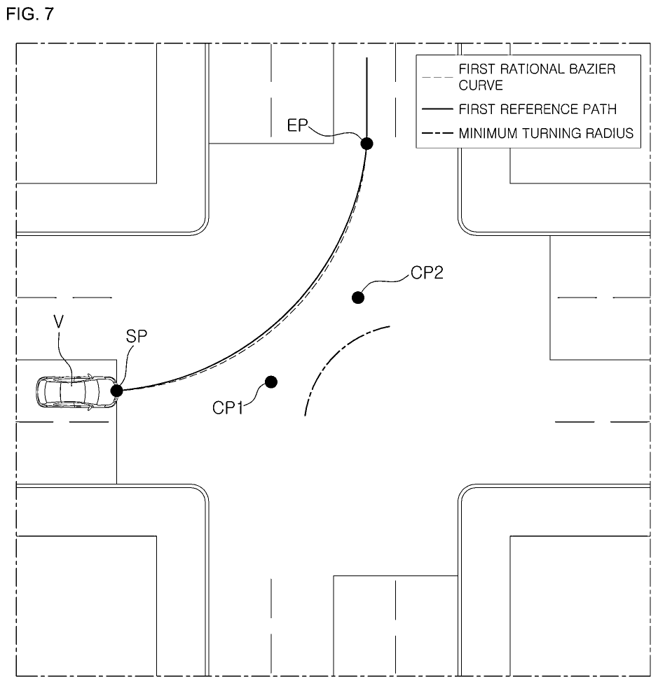

FIG. 7 is a view for describing determining the first rational Bezier curve to be a first reference path in the apparatus for driver assistance according to the embodiment and performing autonomous traveling control.

Referring to FIG. 7, the first rational Bezier curve is determined to be the first reference path that a host vehicle V follows for a left turn, and the autonomous traveling control for allowing the host vehicle V to autonomously travel along the first reference path for the left turn is performed.

Therefore, it is possible to plan and provide a safe reference path that the host vehicle may follow at the cross intersection, thereby securing traveling safety at the cross intersection.

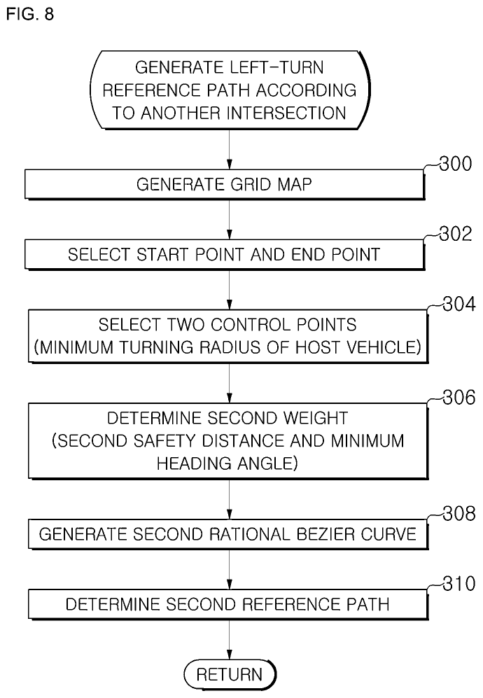

FIG. 8 is a view for describing generating left-turn reference paths according to another intersection in the method for driver assistance according to the embodiment.

Referring to FIG. 8, the controller 60 generates a grid map by connecting lane lines in a T-type intersection with respect to a lane line for a left turn at another intersection, for example, the T-type intersection on a precision map (300).

Since there is no lane line for the host vehicle to follow at the T-type intersection, the grid map is generated by connecting the lane lines within the T-type intersection with respect to the lane line for the left turn at the T-type intersection using the precision map to generate a path that the host vehicle may follow.

The controller 60 selects a start point SP and an end point EP required for a left turn with respect to landmarks on the grid map (302).

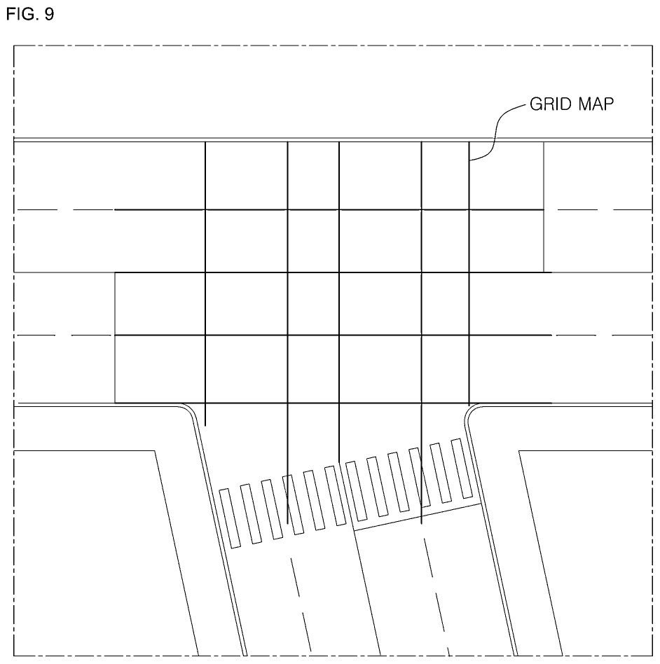

FIG. 9 is a view for describing generating a grid map at another intersection and selecting a start point and an end point required for a left turn in the apparatus for driver assistance according to the embodiment.

Referring to FIG. 9, it is assumed that the host vehicle makes a left turn from a first lane of south way to a first lane of west way at the T-type intersection.

Since the coordinate values of the lane lines may be acquired as global coordinates from the precision map, the grid map is generated by connecting the lane lines within the T-type intersection with respect to the lane lines for the left turn at the T-type intersection.

The start point SP and the end point EP required for the left turn are selected with respect to the landmarks on the grid map.

Referring back to FIG. 8, the controller 60 selects two control points CP1 and CP2 based on a minimum turning radius of the host vehicle (304).

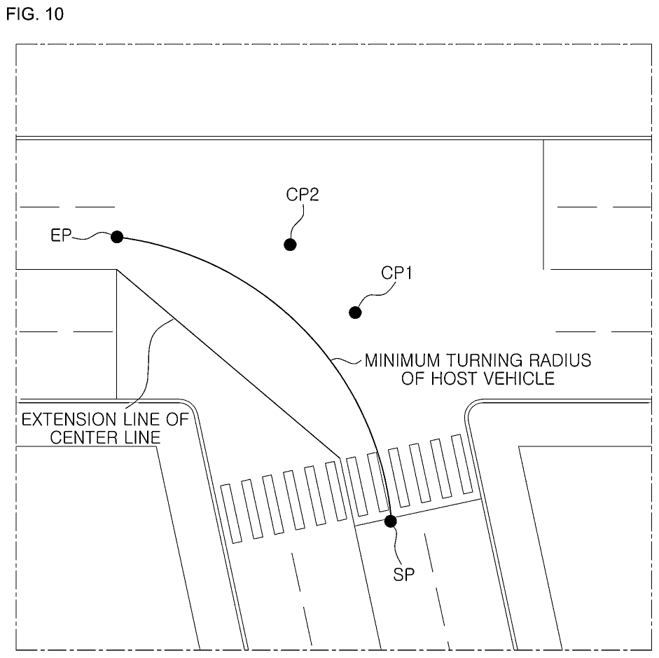

FIG. 10 is a view for describing selecting two control points according to a minimum turning radius of a host vehicle in the apparatus for driver assistance according to the embodiment.

Referring to FIG. 10, first, the minimum turning radius of the host vehicle is determined from an extension line of a center line extending a center line of a left-turn target point to a center line of a start line of the host vehicle on the grid map and lane lines on the grid map. The minimum turning radius may be determined in consideration of the wheel base, king pin, and steering angle of the host vehicle based on the extension line of the center and the lane lines. The minimum turning radius may be a preset value. The minimum turning radius may be a preset value according to the size of the T-type intersection.

The two control points CP1 and CP2 are determined from the minimum turning radius of the host vehicle. For example, the two control points CP1 and CP2 may be determined as points spaced half of a width of the lane from the minimum turning radius of the host vehicle. Two control points CP1 and CP2 are used as control points of the rational Bezier curve.

Referring back to FIG. 8, the controller 60 determines a second weight of a second rational Bezier curve satisfying a second safety distance and a minimum heading angle to generate the second rational Bezier curve spaced the second safety distance or more from the minimum turning radius of a vehicle in a next lane, which may make a left turn together with the host vehicle, and satisfying the minimum heading angle (306).

The controller 60 generates the second rational Bezier curve based on the four points and the second weight (308).

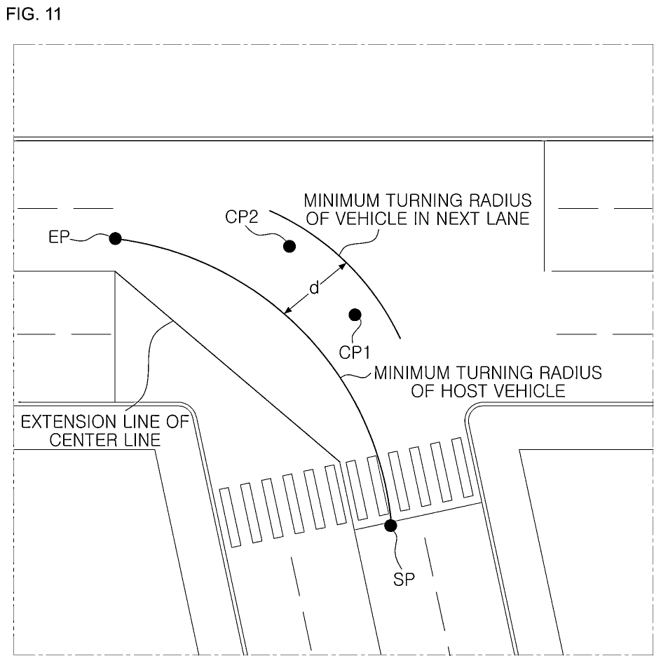

FIG. 11 is a view for describing generating a second rational Bezier curve based on four points and a second weight in the apparatus for driver assistance according to the embodiment.

Referring to FIG. 11, the second rational Bezier curve is generated in the same manner as the first rational Bezier curve. More specifically, the second rational Bezier curve is generated according to the start point SP, the end point EP, the two control points CP1 and CP2, and the second weight (weight that satisfies the second safety distance and the minimum heading angle).

As the second weight is adjusted, a curvature of the second rational Bezier curve is changed and thus a type of the curve is changed.

Constraint condition elements that adjust the curvature of the second rational Bezier curve are the second safety distance d and the minimum heading angle θ.

The second safety distance d is a separation distance between a path of a minimum turning radius of a vehicle in a next lane, which may turn together with the host vehicle, and a path of the second rational Bezier curve. When making a left turn with the minimum turning radius, the vehicle in the next lane maximally approaches the left-turn path of the host vehicle. In order to cope with this case, the path of the host vehicle needs to be spaced the safety distance or more from the path of the vehicle in the next lane. For example, the constraint condition for the second safety distance is a condition in which the second safety distance is half the lane width.

The minimum heading angle is an angle between the path of the second rational Bezier curve and the road. The minimum heading angle is a heading angle at which the host vehicle may smoothly enter the road when making a left turn. For example, the constraint condition for the minimum heading angle is a condition in which the minimum heading angle is smaller than 0.5 deg.

The second rational Bezier curve determines the second weight that satisfies the constraint condition for the second safety distance and the constraint condition for the minimum heading angle. That is, when the second rational Bezier curve is generated, the second weight is determined so that the conditions in which the second safety distance is greater than or equal to half the lane width and the minimum heading angle is smaller than 0.5 deg are satisfied and the second rational Bezier curve becomes a smooth curve with a minimized curvature.

In addition, the second rational Bezier curve is generated based on the start point, the end point EP, the two control points, and the second weight.

Referring back to FIG. 8, the controller 60 determines the second rational Bezier curve to be the second reference path that the vehicle follows (310).

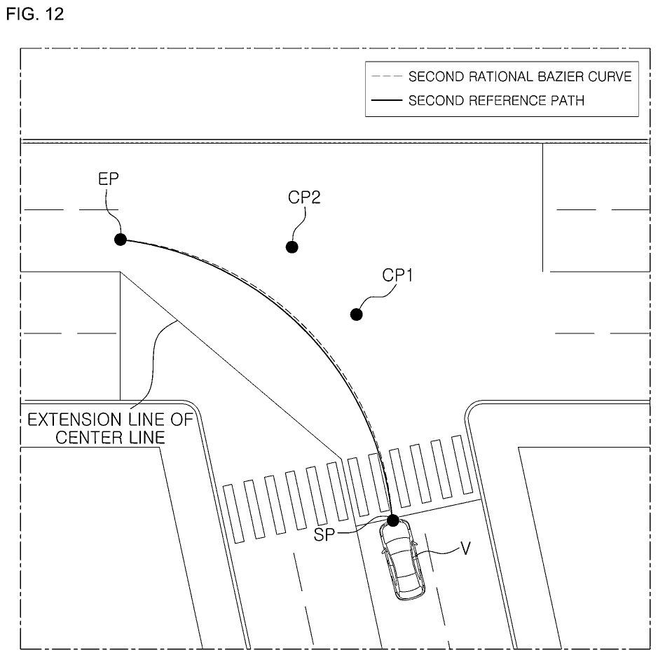

FIG. 12 is a view for describing performing autonomous traveling control by determining the second rational Bezier curve to be a second reference path in the apparatus for driver assistance according to the embodiment.

Referring to FIG. 12, the second rational Bezier curve is determined to be the second reference path that a host vehicle V follows for a left turn, and the autonomous traveling control for allowing the host vehicle V to autonomously travel along the second reference path for the left turn is performed.

Therefore, it is possible to plan and provide the safe reference path that the host vehicle may follow at another intersection such as a T-type intersection, a Y-type intersection, a five-way intersection, or a six-way intersection rather than a cross intersection, thereby securing traveling safety at another intersection.

As described above, even when there are various sizes of the intersections and a large number of left-turn lane lines, it is possible to provide the safe reference path with respect to all intersections in the city, thereby minimizing anxiety about autonomous traveling, overcoming autonomous traveling limiting situations with respect to all intersections in the city, and reducing the rate of traffic accidents.

Although the example in which the weights of the rational Bezier curve are also applied to another intersection has been described in the embodiment, the present disclosure is not limited thereto, and the path of the host vehicle with the minimum turning radius can also be determined as the second reference path.

In addition, although the example in which the second weight is determined in consideration of the minimum turning radius of the left-turn vehicle in the next lane with respect to another intersection has been described, the present disclosure is not limited thereto, and the second weight can be determined to satisfy the sufficient safety distance from the minimum turning radius of the left-turn vehicle in the next lane and the minimum turning radius of the opposite left-turn vehicle in consideration of the minimum turning radius of the opposite left-turn vehicle together when the opposite vehicle can make a left turn.

As is apparent from the above description, it is possible to plan and provide a safe reference path that a host vehicle can follow at an intersection, thereby securing traveling safety at the intersection.

It is possible to plan and provide the safe reference path that the host vehicle can follow with respect to all intersections in the city, thereby securing traveling safety regardless of a size or type of the intersection.

Exemplary embodiments of the present disclosure have been described above. In the exemplary embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. A apparatus for driver assistance, comprising:
a sensor installed in a host vehicle, including at least one of a camera or a radar, and configured to output data;
a memory in which a precision map including intersection information is stored; and
at least one processor electrically connected to the memory and configured to process the data output from the sensor,
wherein the at least one processor is configured to:
generate a grid map by connecting lane lines of an intersection on the precision map when the host vehicle makes a left turn at the intersection,
select a start point and an end point required for the left turn on the grid map,
select at least one control point according to a minimum turning radius of the host vehicle or an opposite left-turn vehicle,
generate a rational Bezier curve based on the start point, the end point, and the at least one control point,
determine the rational Bezier curve to be a left-turn path that the host vehicle follows, and
control the host vehicle based on the processing of the data such that the host vehicle follows the left-turn path.

2. The apparatus of claim 1, wherein the at least one processor is configured to determine a type of the intersection based on the intersection information of the precision map.

3. The apparatus of claim 2, wherein the at least one processor is configured to select the at least one control point according to the minimum turning radius of the opposite left-turn vehicle when the type of the intersection is a cross intersection.

4. The apparatus of claim 3, wherein the at least one processor is configured to select a position point spaced a preset distance from the minimum turning radius of the opposite left-turn vehicle as the at least one control point.

5. The apparatus of claim 3, wherein the at least one processor is configured to:
determine a weight that changes a curvature of the rational Bezier curve so that a distance value between a path of the minimum turning radius of the opposite left-turn vehicle and a path of the rational Bezier curve is greater than a preset safety distance value; and
generate the rational Bezier curve based on the start point, the end point, the at least one control point, and the weight.

6. The apparatus of claim 3, wherein the at least one processor is configured to:
determine a weight that changes a curvature of the rational Bezier curve so that a distance value between a path of the minimum turning radius of the opposite left-turn vehicle and a path of the rational Bezier curve is greater than a preset safety distance value and a minimum heading angle of the host vehicle is smaller than a preset angle; and
generate the rational Bezier curve based on the start point, the end point, the at least one control point, and the weight.

7. The apparatus of claim 2, wherein the at least one processor is configured to select the at least one control point according to the minimum turning radius of the host vehicle when the type of the intersection is another intersection different from a cross intersection, and the other intersection includes any one of a T-type intersection, a Y-type intersection, a five-way intersection, and a six-way intersection.

8. The apparatus of claim 7, wherein the at least one processor is configured to select a position point spaced a preset distance from the minimum turning radius of the host vehicle as the at least one control point.

9. The apparatus of claim 7, wherein the at least one processor is configured to:
determine a weight that changes a curvature of the rational Bezier curve so that a distance value between a path of a minimum turning radius of a left-turn vehicle in a next lane and a path of the rational Bezier curve is greater than a preset safety distance value; and
generate the rational Bezier curve based on the start point, the end point, the at least one control point, and the weight.

10. The apparatus of claim 7, wherein the at least one processor is configured to:
determine a weight that changes a curvature of the rational Bezier curve so that a distance value between a path of a minimum turning radius of a left-turn vehicle in a next lane and a path of the rational Bezier curve is greater than a preset safety distance value and a minimum heading angle of the host vehicle is smaller than a preset angle; and
generate the rational Bezier curve based on the start point, the end point, the at least one control point, and the weight.

11. A method for driver assistance, comprising:
acquiring data output from a sensor, the sensor installed in a host vehicle, including at least one of a camera or a radar, and configured to output data;
acquiring a precision map in which intersection information is stored when the host vehicle makes a left turn at an intersection;
generating a grid map by connecting lane lines of the intersection on the acquired precision map;
selecting a start point and an end point required for the left turn on the grid map;
selecting at least one control point according to a minimum turning radius of the host vehicle or an opposite left-turn vehicle;
generating a rational Bezier curve based on the start point, the end point, and the at least one control point;
determining the rational Bezier curve to be a left-turn path that the host vehicle follows; and
controlling the host vehicle based on the processing of the data such that the host vehicle follows the left-turn path.

12. The method of claim 11, wherein the selecting of the at least one control point comprises determining a type of the intersection based on the intersection information of the acquired precision map.

13. The method of claim 12, wherein the selecting of the at least one control point comprises selecting the at least one control point according to the minimum turning radius of the opposite left-turn vehicle when the type of the intersection is a cross intersection.

14. The method of claim 13, wherein the selecting of the at least one control point comprises selecting a position point spaced a preset distance from the minimum turning radius of the opposite left-turn vehicle as the at least one control point.

15. The method of claim 13, wherein the generating of the rational Bezier curve comprises:
determining a weight that changes a curvature of the rational Bezier curve so that a distance value between a path of the minimum turning radius of the opposite left-turn vehicle and a path of the rational Bezier curve is greater than a preset safety distance value; and
generating the rational Bezier curve based on the start point, the end point, the at least one control point, and the weight.

16. The method of claim 13, wherein the generating of the rational Bezier curve comprises:
determining a weight that changes a curvature of the rational Bezier curve so that a distance value between a path of the minimum turning radius of the opposite left-turn vehicle and a path of the rational Bezier curve is greater than a preset safety distance value and a minimum heading angle of the host vehicle is smaller than a preset angle; and
generating the rational Bezier curve based on the start point, the end point, the at least one control point, and the weight.

17. The method of claim 12, wherein the selecting of the at least one control point comprises selecting the at least one control point according to the minimum turning radius of the host vehicle when the type of the intersection is another intersection different from a cross intersection, the other intersection includes any one of a T-type intersection, a Y-type intersection, a five-way intersection, and a six-way intersection.

18. The method of claim 17, wherein the selecting of the at least one control point comprises selecting a position point spaced a preset distance from the minimum turning radius of the host vehicle as the at least one control point.

19. The method of claim 17, wherein the generating of the rational Bezier curve comprises:
determining a weight that changes a curvature of the rational Bezier curve so that a distance value between a path of a minimum turning radius of a left-turn vehicle in a next lane and a path of the rational Bezier curve is greater than a preset safety distance value; and
generating the rational Bezier curve based on the start point, the end point, the at least one control point, and the weight.

20. The method of claim 17, wherein the generating of the rational Bezier curve comprises:
determining a weight that changes a curvature of the rational Bezier curve so that a distance value between a path of a minimum turning radius of a left-turn vehicle in a next lane and a path of the rational Bezier curve is greater than a preset safety distance value and a minimum heading angle of the host vehicle is smaller than a preset angle; and
generating the rational Bezier curve based on the start point, the end point, the at least one control point, and the weight.
